(19) United States
(12) Patent Application Publication
(10) Pub. No.: US 2006/0228928 A1
(43) Pub. Date: Oct. 12, 2006

(54) Ball storage device

(76) Inventor: Phillip M. Olesen, Plano, TX (US)

Correspondence Address: CRUTSINGER & BOOTH, 1601 ELM STREET, SUITE 1950, DALLAS, TX, 752014744, US

(21) Appl. No.: 11/103,045

(22) Filed: Apr. 11, 2005

(51) Int. Cl. H01R 13/62

(52) U.S. Cl. 439/327

(57) ABSTRACT

The invention provides a storage cart assembly comprising: a) a receptacle of a size and configuration for receiving balls; b) a vertically movable platform within the receptacle for supporting the balls; and c) a spring assembly operably attached to the receptacle and the vertically movable platform, the spring assembly biasing the platform upwards, the platform automatically moving downwards as the receptacle is filled with balls, and the platform automatically moving upwards as the receptacle is emptied of balls in response to the weight of the balls and the biasing of the spring assembly. The invention also provides for a storage cart assembly kit for attachment to a receptacle for receiving balls, the kit comprising: a) a vertically movable platform for supporting the balls, the platform is attachable to the receptacle; and b) a spring assembly operably attachable to the receptacle and the vertically movable platform, the spring assembly biasing the platform automatically moving downwards as the receptacle is filled with balls, and the platform automatically moving upwards as the receptacle is emptied of balls in response to the weight of the balls and the biasing of the spring assembly.

### FIELD OF THE INVENTION

The invention relates to a device for storing athletic balls, and more specifically, involves a device to support the balls in a convenient serving position.

### BACKGROUND OF THE INVENTION

During sporting activities such as tennis or baseball, a large number of balls are used in efforts to improve athletic skills. Various carts have been designed to store athletic balls; however, these devices all suffer shortcomings in that they require a player to pick up or otherwise manipulate a storage cart in order to access a ball. Further, prior art devices require the user to retrieve balls from a decreasing height as the cart is gradually emptied. For example, a tennis coach typically feeds hundreds of balls a day to his students. It is laborious and strenuous on a coach's back to bend over each time to access each ball. A coach has to be able to access balls without looking for them and bending over time after time. Also, the lesson is slowed down as the number of balls in the basket decreases, and the user must bend over further to find a ball. It is difficult in such a circumstance to keep the lesson going at a fast pace, especially in large teaching groups.

Thus, there is a need for a storage cart that enables a user to conveniently access balls from the storage cart.

### SUMMARY OF THE INVENTION

The invention provides a storage cart assembly comprising: a) a receptacle of a size and configuration for receiving balls; b) a vertically movable platform within the receptacle for supporting the balls; and c) a spring assembly operably attached to the receptacle and the vertically movable platform, the spring assembly biasing the platform upwards, the platform automatically moving downwards as the receptacle is filled with balls, and the platform automatically moving upwards as the receptacle is emptied of balls in response to the weight of the balls and the biasing of the spring assembly.

The invention also provides a storage cart assembly kit for attachment to a receptacle for receiving balls, the kit comprising: a) a vertically movable platform for supporting the balls, the platform is attachable to the receptacle; and b) a spring assembly operably attachable to the receptacle and the vertically movable platform, the spring assembly biasing the platform automatically moving downwards as the receptacle is filled with balls, and the platform automatically moving upwards as the receptacle is emptied of balls in response to the weight of the balls and the biasing of the spring assembly.

Other features and many attendant advantages of the invention will become more apparent upon a reading of the following detailed description together with the drawings in which like reference numerals refer to like parts throughout.

### BRIEF DESCRIPTION OF THE DRAWINGS

The accompanying figures of the drawings are incorporated into and form a part of the specification to illustrate several examples of the present inventions. These drawings together with the description serve to explain the principles of the inventions. The figures are only for illustrating preferred and alternative examples of how the inventions can be made and used and are not to be construed as limiting the inventions to the illustrated and described examples. The various advantages and features of the present inventions will be apparent from a consideration of the drawing in which:

FIG. 1A illustrates a side view of a preferred embodiment of the storage cart assembly of the present invention when the receptacle is only half filled with balls;

FIG. 1B illustrates a side view of the storage cart assembly of FIG. 1 in the service position;

FIG. 2 illustrates a front view of the storage cart assembly of FIG. 1;

FIG. 3 illustrates a top view of the storage cart of FIG. 1, where the receptacle is in the open position;

FIG. 4 illustrates a top view of the storage cart of FIG. 1, where the receptacle is in the closed position;

FIG. 5 illustrates an enlarged side sectional view of a spring assembly that is assembled into the posts of the storage cart assembly;

FIG. 6 illustrates an enlarged side sectional view of a compression spring tube embodiment such as a helically coiled compression spring that is assembled into the storage cart assembly; and

FIG. 7 illustrates a front elevational perspective view of an alternate embodiment of the storage cart assembly.

### DETAILED DESCRIPTION OF THE INVENTION

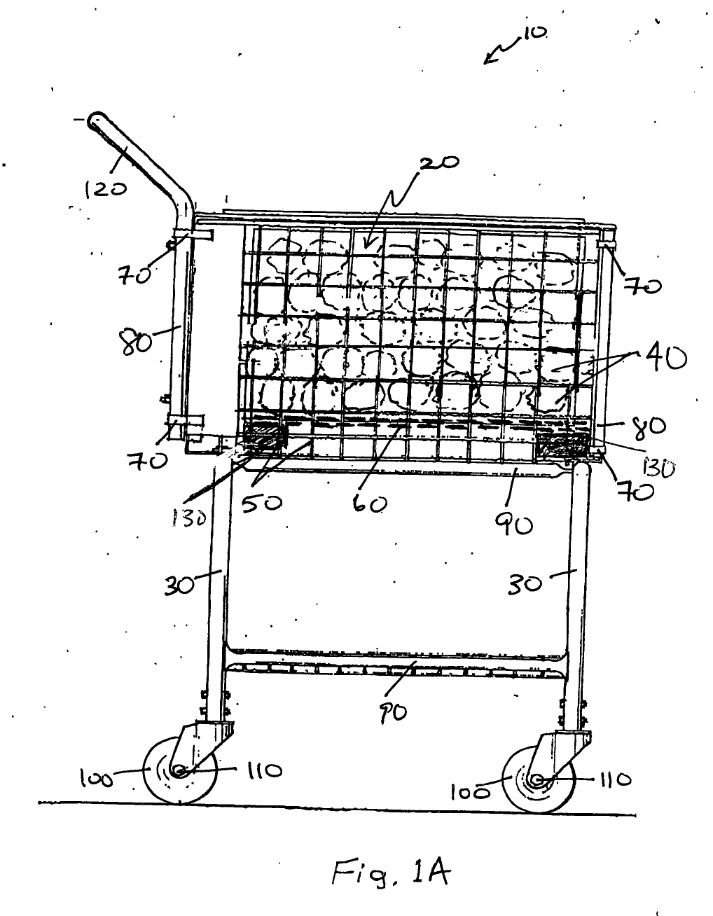

Referring initially to FIG. 1A, illustrated is a side view of a preferred embodiment of the storage cart assembly 10 of the present invention when the receptacle 20 is filled with balls 40. The storage cart assembly 10 generally comprises a receptacle 20, and preferably, a frame 30 that supports the receptacle 20. The receptacle 20 defines a container volume for containing a quantity of balls 40, such as tennis balls, base balls, or any other kind of athletic balls. The receptacle 20 preferably includes a plurality of generally upright side walls 8 framed by rods 50, and a generally horizontal platform 60. The storage cart assembly 10 also contains a spring assembly 130 that is operatively connected to the platform 60 for upwardly biasing the platform 60. The spring assembly is designed to raise the platform 60 as it is emptied of balls 40 and allow the platform 60 to lower as it is filled with balls 40. FIG. 1A illustrates the position of the platform 60 when the receptacle 20 is filled with balls 40. It is also contemplated that the spring assembly need not be operably connected to the receptacle and the vertically movable platform, so long as the spring assembly serves to bias the platform-automatically moving downwards as the receptacle is filled with balls and automatically moving upwards as the receptacle is emptied of balls in response to the weight of the balls and the biasing of the spring assembly. The invention advantageously enables the player to access a ball without having to bend over to a different height each time to reach for the balls as the receptacle 20 empties. Also, the player is able to access the balls with less delay caused by having to feed balls to a player during a lesson, especially as the receptacle 20 gets close to becoming empty.

The receptacle 20 comprises sidewalls that are defined by rods 50 and mesh. Rods 50 are spaced apart and preferably support mesh to form the receptacle 20. Solid, perforated or mesh constructions can be used for the sidewalls. The sidewalls can be made of any suitable material, such as metal wires or plastic. Metal or plastic rods advantageously provide a light-weight storage cart. Rods 50 are not necessary and may be eliminated to prevent friction as the platform 60 rises.

The frame 30 functions to support the receptacle 20. The spring assembly and the platform 60 may be assimilated into the receptacle 20 by a connector means 70, such as clamps screws, or other fasteners. As illustrated in FIG. 1A, the frame 30 can be made up of a plurality of posts 80 can be vertically positioned outside the receptacle 20 and adjacent each corner of the side walls. Spanning members 90 can also be attached to the posts 80 to form part of the frame 30.

The cart 10 can include a wheel assembly 100 for rollingly supporting the storage cart assembly 10. The wheel assembly 100 can include wheels, rollers, coasters, or any other conveyance that movably supports the frame 30. Various wheel constructions may be employed to provide the swiveling and rolling movement desired. Typically, the cart 10 includes front wheels and rear wheels. The wheel means 100 can be attached to the cart 10 by an axle 110. The wheel assembly 100 enables the player to roll the cart 10 to various playing locations.

Preferably, the frame 30 includes a handle 120. The handle 120 can provide a means to push, pull, and steer the cart assembly to a desired location. Handle 120 can be fixedly or hingidly attached to the frame 30. The handle 120 can also be attached to the frame 30 by outwardly extendable tubular bars that can be adjusted to a user's preferred height.

Turning now to FIG. 1B, illustrated is a side view of the storage cart assembly of FIG. 1A in the service position. FIG. 1B portrays the storage cart assembly 10 when the receptacle 20 is partially empty. As fewer balls 40 are contained within the receptacle 20, the platform 60 elevates and pushes the tennis balls 40 upward. Conversely, the platform 60 lowers when the cart is filled with balls 40. The weight of the added balls compresses the spring assembly 130, thereby lowering the platform. Conversely, as balls are removed and less weight acts on the platform 60, the spring assembly 130 automatically elevates the platform. Accordingly, the horizontal platform 60 is automatically moved to an elevated position, or service position, such that the player can conveniently access a ball. The spring assembly 130 is shown in an extended or elevated position in FIG. 1B. Thus, the receptacle 20 not only serves to store the balls, but also lifts the balls upward as the quantity of balls in the receptacle 20 decreases.

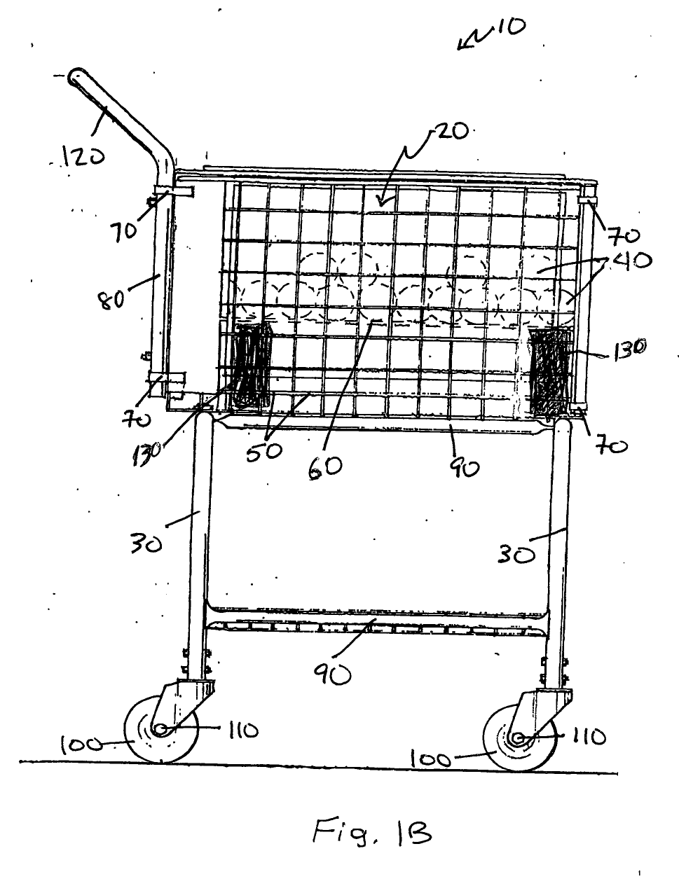

Turning now to FIG. 2, illustrated is a front view of the storage cart assembly 10 of FIG. 1. As mentioned previously, the frame 30 can include a plurality of spaced apart posts 80. Also, the cart 10 can include spanning members 90 as a means to support the receptacle 20. Also illustrated in FIG. 2 are the platform 60, connectors 70, wheel assembly 100, axles 110, and handle 120.

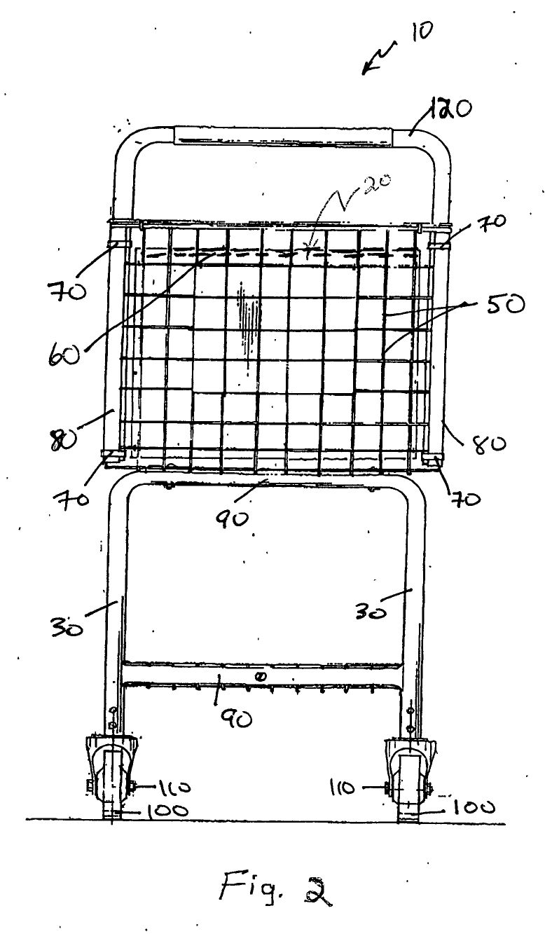

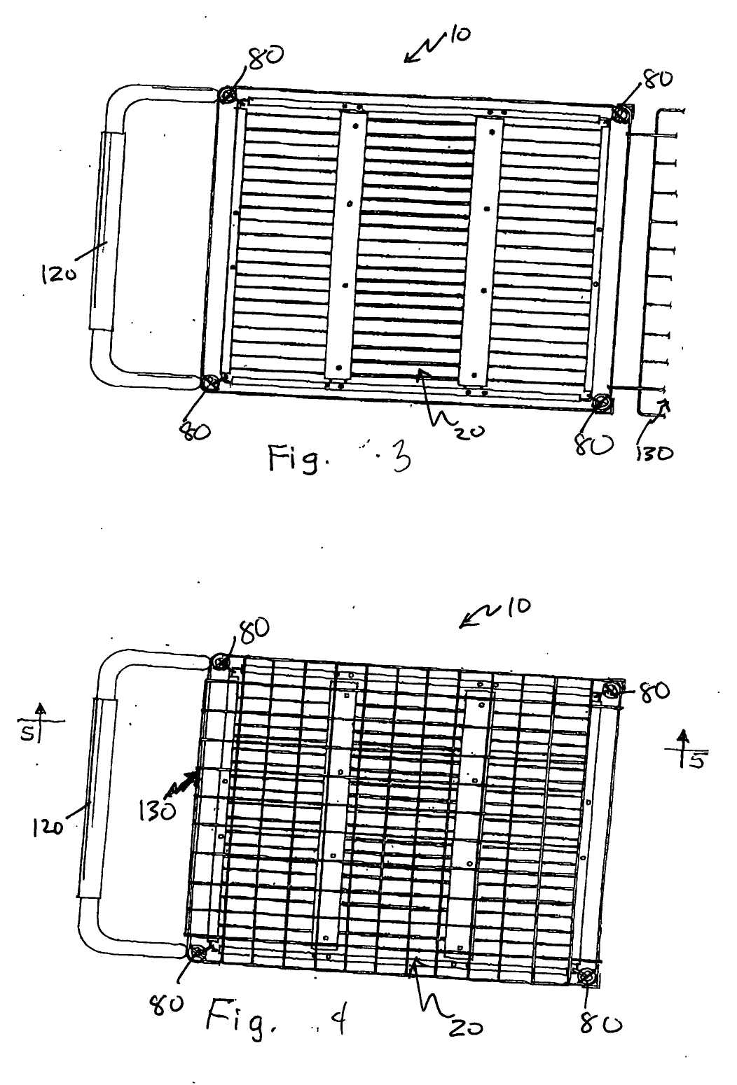

Turning to FIG. 3, illustrated is a top view of the storage cart 10 of FIG. 1, and a receptacle cover 130 of the receptacle 20 in its open position. The receptacle 20 may include a receptacle cover 130 that lockingly engages the receptacle 20. As illustrated, receptacle 20 is a generally rectangular receptacle surrounding an inner opening for storage of tennis balls. A receptacle cover 130 can be used to lock the balls within the receptacle 20. Also clearly illustrated in FIG. 3 is the plurality of posts 80 and the handle 120 that make up the frame 30. FIG. 4 illustrates a top view of the storage cart 10 of FIG. 1, where the receptacle cover 130 encloses the receptacle 20.

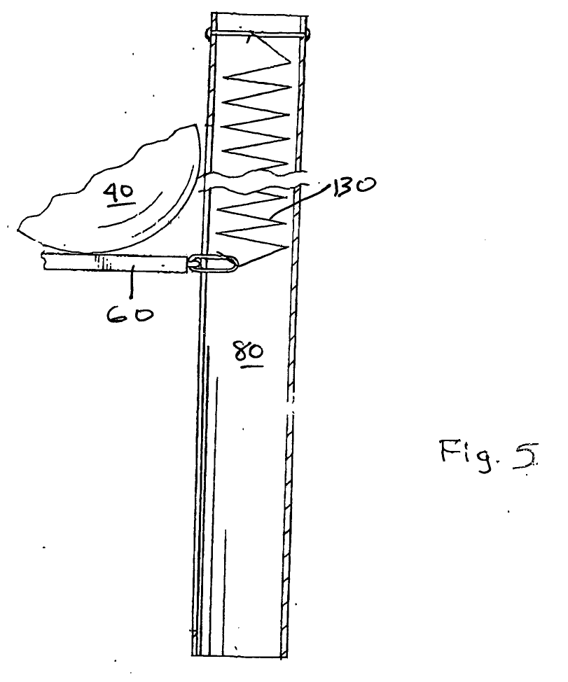

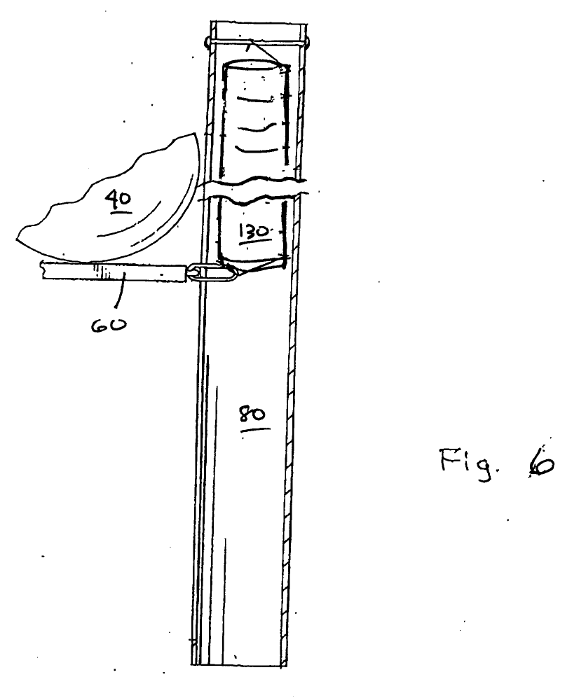

Turning to FIG. 5, illustrated is an enlarged side sectional view of a spring assembly 130, which has been assembled into posts 80 of the storage cart assembly 10. The spring assembly 130 can be integrated into the posts of the frame, placed under the platform 60, as in FIGS. 1A and 1B, or otherwise mounted. If mounted, the spring assembly may be connected to the receptacle by a connector such as a clamp, screw, glue, or other fastener. The particular placement of the spring assembly is not critical, and practitioners will recognize that the spring assembly can be mounted in any location as long as it is operable to elevate and lower the platform 60. Also illustrated in FIG. 5 is the platform 60 that is upwardly biased and elevates as the quantity of balls 40 decreases within the receptacle. Preferably, spring assembly 130 is sufficient to elevate the platform 60 to near or at the top of the receptacle when there is few or no balls present. The frame and the spring assembly 130 accommodate sufficient upward movement to enable the platform 60 to effect a higher position against the biasing of the spring assembly 130 as well as to provide a platform 60 to contain the tennis balls 40 within the receptacle. The platform 60 is upwardly biased by any spring assembly 130, including compression springs, tension springs, torsion springs, hydraulic springs, and other springs known in the art. FIG. 6 illustrates an enlarged side sectional view of a compression spring 132, such as a helically coiled compression spring, which is assembled into the storage cart assembly. The spring assembly 130 can be integrated into the posts 80 of the frame or connected to the posts 80. The spring assembly 130 can comprise a plurality of springs 132 located at each corner of the receptacle, wherein each spring 132 is operatively attached to a post 80. The spring assembly 130 can be clamped onto one or more of the plurality of posts 80. The compression spring 132 is compressively loaded to upwardly bias the platform 60. The preload compression can be made to be sufficient to maintain the elevated transport position of the platform, supporting the weight of the platform. When fully loaded with balls, the springs 132 are selected to support the weight of the platform, a full quota of stored tennis balls, as well as design allowances, without the plastic deformation or damage to the springs.

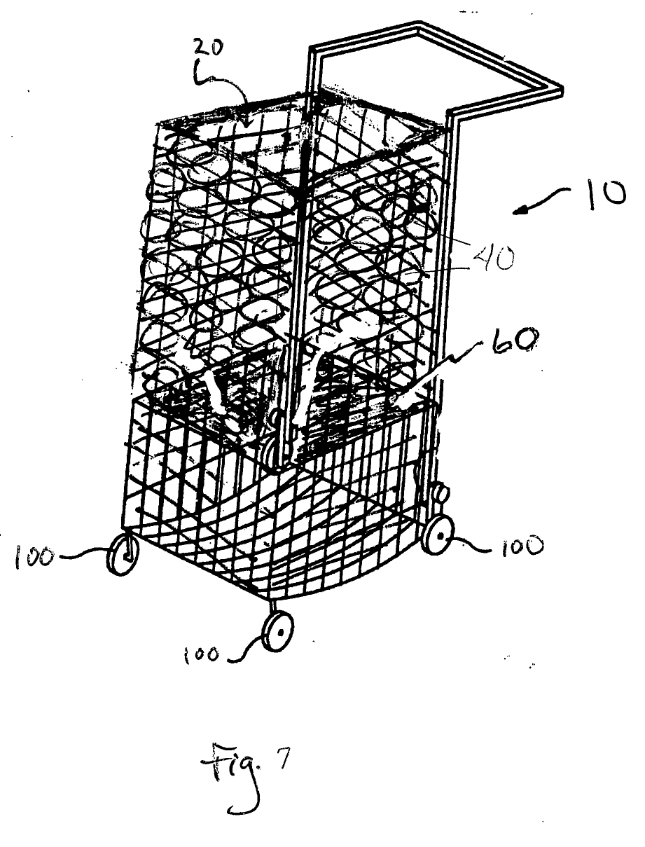

Turning now to FIG. 7, illustrated is a front elevational perspective view of an alternate embodiment of the storage cart assembly 10. Sidewalls extend to the ground to provide more storage volume. The platform 60 is elevated to a level that will allow a player to access the balls 40 at the top end of the receptacle 20. Also shown is the wheel assembly 100 that rollingly supports the cart 10 to allow the user to transport the cart 10 to different locations of the court. It should be understood by those skilled in the art that the platform 60 and accompanying spring assembly may be assimilated into or mounted onto any suitable receptacle 20. A shopping cart-type receptacle as illustrated in FIGS. 1-6 or a full-length receptacle as illustrated in FIG. 7 are only exemplary embodiments for a receptacle, so long as a platform 60 is employed to elevate the balls as the quantity of the balls 40 in the receptacle 20 decreases.

In use, the cart may be used as a storage device for tennis balls or other balls such as baseballs, volleyballs, etc. The cart can be made to be rollable onto the playing surface and transferred to a different location without requiring manual lifting. During a practice session, the cart 10 may be used for conveniently accessing the tennis balls at the upper end of the receptacle. It is also contemplated that the present invention can be designed to retrieve tennis balls from the ground as well as elevate the balls as the quantity of balls in the receptacle 20 decreases. Such a device would include a means for retrieving tennis balls from the ground as illustrated in U.S. Pat. No. 5,301,991, which is incorporated herein by reference in its entirety.

In one embodiment, the invention provides a storage cart assembly kit for attachment to a receptacle for receiving balls, the kit comprising: a) a vertically movable platform for supporting the balls, wherein the platform is attachable to the receptacle; and b) a spring assembly operably attachable to the receptacle and the vertically movable platform, the spring assembly biasing the platform automatically moving downwards as the receptacle is filled with balls and automatically moving upwards as the receptacle is emptied of balls in response to the weight of the balls and the biasing of the spring assembly. The vertically movable platform of the invention can be attachable to any given receptacle. Alternatively, the kit can include a receptacle as well. It is also contemplated that the spring assembly need not be operably attachable to the receptacle and the vertically movable platform, so long as the spring assembly serves to bias the platform-automatically moving downwards as the receptacle is filled with balls and automatically moving upwards as the receptacle is emptied of balls in response to the weight of the balls and the biasing of the spring assembly.

The kit can also include connectors for attaching the spring assembly to the platform and a given receptacle. Alternatively, the spring assembly can be attachable to a given receptacle by assembling the spring assembly into existing posts in a given receptacle. The kit can also comprise a plurality of posts that are attachable to a given receptacle by a claim. The spring assembly can comprise plurality of springs, each biasing the platform upwards.

The kit can also include side panels that are attachable to the side walls of a given receptacle. The side panels can advantageously serve to prevent the balls from becoming lodged in between the space that commonly separates a platform and a conventional storage cart's sidewall. The kit can also comprise a handle that is attachable to a given receptacle.

Although a particular embodiment of the invention has been illustrated and described, various changes may be made in the form, composition, construction, and arrangement of the parts without sacrificing any of its advantages. Therefore, it is to be understood that all matter herein is to be interpreted and illustrative and not in any limiting sense and it is intended to cover in the appended claims such modifications as come within the true spirit and scope of the invention.

What is claimed is:

1. A storage cart assembly comprising:
a. a receptacle of a size and configuration for receiving balls;
b. a vertically movable platform within the receptacle for supporting the balls;
c. a spring assembly operably attached to the receptacle and the vertically movable platform, the spring assembly biasing the platform upwards, the platform automatically moving downwards as the receptacle is filled with one or more balls, and the platform automatically moving upwards as the receptacle is emptied of balls in response to the weight of the balls and the biasing of the spring assembly.

2. The storage cart assembly according to claim 1, wherein the spring assembly is attached to the platform and the receptacle by a connector.

3. The storage cart assembly according to claim 2, wherein the connector includes at least one clamp.

4. The storage cart assembly according to claim 1, wherein the receptacle has at least one post, and the spring assembly is attached to the at least one post of the receptacle.

5. The storage cart assembly according to claim 1, wherein the spring assembly comprises a plurality of springs, each biasing the platform upwards.

6. The storage cart assembly according to claim 5, wherein each spring is mounted inside a tubular member.

7. The storage cart assembly according to claim 1, wherein the spring assembly comprises at least one helically-coiled compression spring.

8. The storage cart assembly according to claim 1, wherein the spring assembly comprises at least one tension spring.

9. The storage cart assembly according to claim 1, wherein the spring assembly comprises at least one hydraulic system.

10. The storage cart assembly according to claim 1, wherein the receptacle further includes side panels.

11. The storage cart assembly according to claim 1, wherein the receptacle further includes a cover that lockingly engages the receptacle.

12. A storage cart assembly kit for attachment to a receptacle for receiving balls, the kit comprising:
a. a vertically movable platform for supporting the balls, the platform is attachable to the receptacle; and
b. a spring assembly operably attachable to the receptacle and the vertically movable platform, the spring assembly biasing the platform automatically moving downwards as the receptacle is filled with balls, and the platform automatically moving upwards as the receptacle is emptied of balls in response to the weight of the balls and the biasing of the spring assembly.

13. The storage cart assembly kit according to claim 12, wherein the spring assembly is attachable to the platform and the receptacle by a connector.

14. The storage cart assembly kit according to claim 13, wherein the connector includes at least one clamp.

15. The storage cart assembly kit according to claim 12, wherein the receptacle has at least one post and wherein the spring assembly is attachable to the at least one post of the receptacle.

16. The storage cart assembly kit according to claim 12, wherein the spring assembly comprises a plurality of springs, each biasing the platform upwards.

17. The storage cart assembly kit according to claim 2, wherein each spring assembly is mountable inside a tubular member.

18. The storage cart assembly kit according to claim 12, wherein the spring assembly comprises at least one helically-coiled compression spring.

19. The storage cart assembly kit according to claim 12, wherein the spring assembly comprises at least one tension spring.

20. The storage cart assembly kit according to claim 12, wherein the spring assembly comprises at least one hydraulic system.
